(19) United States
(12) Patent Application Publication
(10) Pub. No.: US 2005/0114825 A1
(43) Pub. Date: May 26, 2005

(54) Laptop computer including a touch-sensitive display and method of driving the laptop computer

(75) Inventors: Ying Tat Leung, Tarrytown, NY (US); Menachem Levanoni, Poway, CA (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/718,642

(22) Filed: Nov. 24, 2003

(51) Int. Cl. G06F 9/44

(52) U.S. Cl. 717/100

(57) ABSTRACT

The laptop computer includes a first display, and a second display attachable to the first display. The second display is a touch-sensitive display.

### BACKGROUND OF THE INVENTION

1. Field of the Invention

The present invention generally relates to a computer method, system and structure for providing a user interface that includes two displays, at least one of which being a touch-sensitive display that is customizable for display or input by a software application.

2. Description of the Related Art

An attribute of a laptop computer (hereinafter called a “laptop”) is its compactness. Recent developments in hardware such as the decreasing size of hard drives and the use of easily exchangeable hardware components (e.g., the CD-ROM is easily exchangeable with a floppy drive while the computer is running) have contributed to the slim profile of the current generation laptops. However, there are two components that exhibit conflicting design goals, namely the display screen and the keyboard. While these should be small in physical size to make the entire laptop mobile, their size also should be large from a usability point of view.

Additionally, a large number of laptops are used for business presentations and discussions while the user is traveling, thereby necessitating a large display.

### SUMMARY OF THE INVENTION

In view of the foregoing and other exemplary problems, drawbacks, and disadvantages of the conventional methods and structures, an exemplary feature of the present invention is to provide a method and structure in which a laptop computer is provided with two displays, one of which is a touch-sensitive display.

In a first exemplary aspect of the present invention, a laptop computer includes a first display, and a second display attachable to the first display. The second display includes a touch-sensitive display. Preferably, the second display is rotatably attached to the first display.

In a second exemplary aspect of the present invention, a method for driving a laptop computer having a first display rotatably attachable to a second display that is touch-sensitive includes displaying a user-interface on the second display, and receiving an input from the user-interface.

In a third exemplary aspect of the present invention, a signal-bearing medium tangibly embodying a program of machine-readable instructions executable by a digital processor for driving a laptop computer having a first display rotatably attachable to a second display that is touch-sensitive apparatus, includes instructions for displaying a user-interface on the second display, and instructions for receiving an input from the user-interface.

In a fourth exemplary aspect of the present invention a laptop computer includes a first display, and a second display attachable to the first display. The second display including a customizable user-interface.

An exemplary embodiment of the present invention roughly doubles the size of a typical laptop display without a significant increase in the physical size of the laptop computer. This exemplary embodiment achieves this feature by exploiting the fact that the keyboard is not needed for a significant portion of the time the laptop is in use (e.g., during a presentation), or for the entire duration of certain applications (e.g., reading an electronic book).

An exemplary embodiment of the present invention includes a standard display and replaces the traditional keyboard with a touch-sensitive display. When a keyboard is desired (such as in word processing), an image of a keyboard (e.g., a “virtual” keyboard) may be generated on the touch-sensitive display by a software application. In this manner, the present invention enables the user to type on (e.g., key in alpha-numeric characters and symbols) the touch-sensitive display, just as with a traditional, mechanical (e.g., physical) keyboard. Then, when the typing/keying in (e.g., through the virtual keyboard) is no longer desired, the touch-sensitive display may then serve as part of a larger display in combination with another display.

In another exemplary embodiment of the present invention, a keyboard may be displayed on the touch-sensitive display that may be customized by the particular software application that is being used. For example, an application may display a keyboard that includes color-coded keys, keys that are uniquely labeled for a particular application, and keys that may be specially labeled for certain operations during operation of an application. In other words, with an exemplary embodiment of the present invention, a keyboard may be displayed on a touch-sensitive display that is customized to a particular application, a particular user, and/or customized dynamically based on the need of the application and/or user at any point in time. This feature gives application developers a new degree of freedom in user interface design.

A laptop equipped with an exemplary embodiment of the present invention may also be handled like a traditional paper book, with the two displays showing two consecutive pages of text, respectively. This is similar to the way an open paper book may show two consecutive pages. This exemplary feature enhances the usability of a laptop computer as an alternative medium to deliver book content to a user. The electronic medium that is provided by the present invention has many advantages, such as a reduced cost of delivery that is incurred by the publisher, a reduced physical space that is incurred by the user and, thus, the ability to have a larger library if desired, and increased mobility of the book content for the user.

An exemplary embodiment of the present invention addresses the problems of the current status of laptop designs that use a traditional display along with a keyboard that is static in nature and is limited to hard-coded cases/keys.

In stark contrast to the conventional laptop computers, an exemplary embodiment of the present invention is dynamic in nature, may effectively double the display size with a minimal increase in physical size, and is not limited to a few hard coded keyboard cases.

In another exemplary embodiment of the present invention, input errors in software applications may be reduced by disabling or hiding parts of the keyboard that are not allowed and/or appropriate for the current state of the application. For example, certain portions of the keyboard may not be relevant to a current prompt or a current field of input such as when the application is waiting for input of a number, the alphabet part of the keyboard can be disabled (“grayed out”) or simply not shown on the display, thereby leaving only the numeric keypad on the display. As such, the display is much more user friendly and interactive.

In another exemplary embodiment of the present invention, a numeric keypad may be generated dynamically and placed on top of the alphabet keyboard, at a convenient position so that the user does not need to move his hands to enter numbers.

In yet another exemplary embodiment of the present invention, when the system is waiting for input to a “yes” or “no” question, relatively large “yes” and “no” labels may be generated on top of the alphabet keyboard for easy input by the user.

In a further exemplary embodiment of the present invention, user menus or tool bars that are typically located at the top of a software application window and which, therefore, require the user to move a hand from the keyboard to a pointer device (such as a mouse) to access the menu or tool bar, may be located at the top of the alphabet keyboard for convenient access. In this manner, a user will not have to remove their hand from the keyboard to use a pointing device.

Similarly, in another exemplary embodiment of the present invention, drop down menus may be generated from a user menu, that is positioned at the top of the keyboard. These user menus may be displayed in a position such that a drop down menu may cover part of the keyboard while the drop down menu is active and waiting for user input.

These and many other advantages may be achieved by these illustrated and other embodiments of the present invention.

### BRIEF DESCRIPTION OF THE DRAWINGS

The foregoing and other exemplary purposes, aspects and advantages will be better understood from the following detailed description of exemplary embodiments of the invention with reference to the drawings, in which:

FIG. 1 illustrates a laptop computer 100 of an exemplary embodiment of the present invention that includes a plurality of (e.g., two in a non-limiting embodiment) displays 110 and 120, one of which is a touch-sensitive display 110;

FIG. 2 illustrates the laptop computer 100 of FIG. 1 in a planar configuration;

FIG. 3 illustrates the laptop computer 100 of FIG. 1 displaying a user-interface on the touch-sensitive display 110;

FIG. 4 illustrates the laptop computer 100 of FIG. 1 displaying an electronic book;

FIG. 5 illustrates an exemplary hardware/information handling system 500 for incorporating the present invention therein;

FIG. 6 illustrates a signal bearing medium 600 (e.g., storage mdium) for storing steps of a program of a method according to the present invention; and

FIG. 7 illustrates a flowchart for an exemplary control routine in accordance with the present invention.

### DETAILED DESCRIPTION OF EXEMPLARY EMBODIMENTS OF THE INVENTION

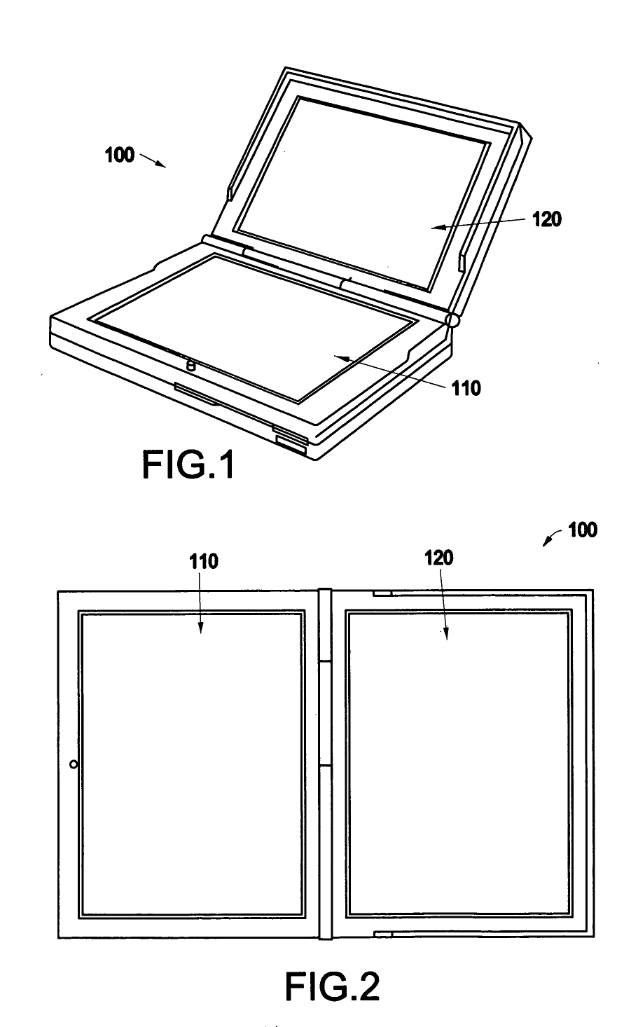

Referring now to the drawings, and more particularly to FIGS. 1-7, there are shown exemplary embodiments of the method and structures according to the present invention.

A first exemplary embodiment in accordance with the present invention is illustrated in FIG. 1. FIG. 1 shows a perspective view of a laptop computer 100 with a software-configurable touch-sensitive display 110. The laptop computer 100 includes a touch-sensitive display 110 that is rotatably attached (i.e. hinged) to another display 120 that may, optionally, also be a touch-sensitive display.

While the exemplary embodiments show two displays (and for simplicity such will be assumed below) the invention is not limited to only two displays and, indeed, may include any number of displays.

The laptop computer of an exemplary embodiment of the present invention is capable of generating a user-interface (e.g., a virtual keyboard) on the touch-sensitive display that is configured by the control routine (e.g., software that includes instructions for a control routine to display a user-interface). In other words, the present invention is capable of providing a customizable and/or reconfigurable user-interface in accordance with a software application that is being executed on the laptop computer.

As shown by FIG. 1 the touch-sensitive display 110 may be provided at the location that has conventionally been reserved for a mechanical keyboard in the conventional laptop computers. As explained above, conventional laptop computers include a display that is rotatably attached (i.e. hinged) to a mechanical keyboard.

In stark contrast, as shown by FIG. 1, an exemplary embodiment of the present invention provides a laptop computer 100 with a display 120 that is rotatably attached to a touch-sensitive display 110.

FIG. 2 shows the first exemplary embodiment of the laptop computer 100 with the two displays 110 and 120 configured such that the displays 110 and 120 are laid flat. In other words, the displays 110 and 120 are substantially parallel to each other. Thus, this laptop computer 100 may be used completely flat and the two displays 110 and 120 may be used together. Such a configuration may be useful, for example, when using the laptop computer 100 to read an electronic book, when making a presentation to a group, or the like.

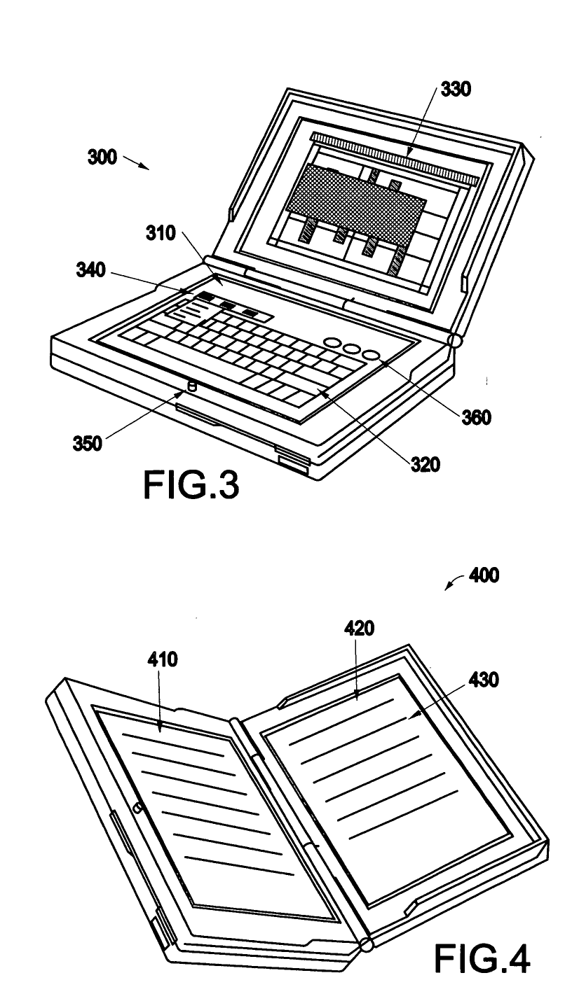

FIG. 3 illustrates a laptop 300 that incorporates an exemplary embodiment of the present invention in an open configuration. The laptop 300 includes a touch-sensitive display 310 on which a keyboard 320 may be displayed. As explained above, the keyboard 320 is merely one example of a user-interface that may be displayed on the touch-sensitive display 310 in accordance with instructions from a software program that is being executed by the laptop computer.

During use, a user may type on the keyboard 320 that is displayed on the touch-sensitive display 310 in a manner that is similar to how one may type on a conventional mechanical keyboard. The user may then monitor the input from the keyboard 320 into the laptop 300 by viewing the second display 330.

Optionally, an audio feedback of keys being pressed (such as click sounds) may be generated by the laptop 300 using built-in speakers (not shown).

While in an exemplary embodiment of the present invention both displays may be liquid crystal displays, the present invention is not limited to liquid crystal displays. For example, the present invention may use any form of liquid crystal display, a plasma display, or the like. Rather, the only limitation is that one of the displays of the laptop computer is touch-sensitive.

Additionally, while at least one of the displays should be touch-sensitive, both displays may be touch-sensitive. With such a configuration, the software designer may display a user interface, such as software-generated alphabetical or numerical keypads, input buttons, user menus, and the like, any place within the two displays.

In an exemplary embodiment of the invention that includes two touch-sensitive displays, a keyboard may be displayed across both of the displays. For example, when the laptop is configured flat (as shown for example in FIG. 2) the two touch-sensitive displays may be used together to display a user-input device such as a keyboard (not shown).

For example, a software application that is being executed by the laptop computer may “split” the conventional keyboard configuration, so that a portion of the software-configurable keyboard may be displayed on each of the touch-sensitive displays. In this manner, a user-interface (e.g., virtual keyboard) may be generated on both of the touch-sensitive displays thereby providing a relatively larger display area for the user-interface and further using a relatively larger display area for receiving input from the user-interface.

Therefore, a keyboard that is much larger than a conventional mechanical keyboard may be displayed across an elongated display that is formed from the two displays. Thus, this exemplary embodiment of the present invention provides a software designer with greater freedom and/or options for using a display. For example, a software designer may vary the aspect ratio of the display and/or the display may be easily reconfigured in accordance with any particular application.

As shown in FIG. 3, when the laptop 300 in accordance with an exemplary embodiment of the present invention is used in a manner that is similar to conventional laptops, the keyboard 320 is displayed on the touch-sensitive display 310. This keyboard 320 may be configured to look similar to a traditional mechanical keyboard, such as, for example, using detailed shadowing techniques in graphics.

Additionally, the keyboard 320 may be customized depending on the need of a particular application.

In an exemplary embodiment of the present invention, the touch sensitive display may be a backlit display. Such a backlit display may illuminate a keyboard so that the laptop computer can be easily used in total darkness, low illumination conditions and the like.

As explained above, in an exemplary embodiment of the present invention, not only may the keyboard be configured in accordance with a particular application, but the keyboard may also be configured in accordance with a user's preferences. For example, a user may choose whether to use a QWERTY or Dvorak keyboard, choose which side a numeric keypad may be displayed go (most likely depending on whether the user is left-handed or right-handed), how long the space bar will be, and the like. Thus, the present invention provides a great deal of flexibility to adapt to a user's preferences, needs and desires.

The keyboard may be configured not only to relocate keys, or other input devices around on the display, but individual keys may also be displayed in unique ways. As an example, the function keys that are conventionally labeled F1 through F12 may be clearly labeled with a symbol that indicates their actual current functions in accordance with a corresponding state of an application. This may be accomplished by using a software application which is capable of taking advantage of the features of the present invention such that keys being displayed on a touch-screen may be labeled, relabeled, moved, put into motion, altered in shape and the like in accordance with the instructions from a software application being executed by the laptop computer of the present invention.

Further; the present invention also allows for dynamically changing the labels on keys in accordance with the current context and/or state of an application. For example, when a keystroke combination is initiated, the labels on the keys may be changed accordingly. One particular example is the keystroke combination is control-F where the “control” key and the “F” key are depressed together. With an exemplary embodiment of the present invention, when the “control” key is depressed, the label on the “F” key may be changed to provide a more specific indication of the function of the “F” key.

In yet another exemplary embodiment of the present invention, not only may keys be labeled in accordance with a particular application, user preference, or the like, but the keys may also be color-coded depending on context. For example, selected keys may be “grayed out” on the display and be made non-responsive to the user when certain characters are not expected or not allowed at certain input instants. As a more specific example, when a cursor is placed on an input field which may be expecting a number, the entire alphabetic section of the keyboard may be made unresponsive and shown as grayed out. Thus, with the present invention, the keyboard may change based on the need of the software application, the user or the like.

In another exemplary embodiment of the present invention, as shown in FIG. 3, a drop-down menu 340 may be displayed. In some instances, an application may choose to put a drop-down menu 340 at the top of a keyboard 320. In this manner, a user may use a finger to directly select menu items from the drop-down menu 340 without removing the user's hands from the general area of the keyboard 320.

In yet another exemplary embodiment of the present invention, an application may place special buttons 360 at the top of the keyboard 320. These buttons may be customized for each application and may represent commonly used functions so that the user can directly access them with minimal hand movement.

Additionally, the display 330 may be used as a conventional output display for text and graphics. A pointing device 350 is also shown at the edge of the touch sensitive display 310, an example of which is an IBM Trackpoint®. Other pointing devices may also be employed, including a joystick, trackball, touch pad, and the like.

Further, as explained above, the laptop 100 may be configured as shown, for example, in FIG. 2, where the displays 110 and 120 are positioned in a common plane. In this manner, the size of the display area may be effectively doubled in comparison to a conventional laptop. Thus, for example, a user may be permitted to view a large spreadsheet in its entirety, examine a CAD drawing more closely, view a detailed map without panning, or the like.

Computer games may also take advantage of a laptop 100 in accordance with an exemplary embodiment of the present invention that incorporates two displays. For example, the game application may use both displays and use any portion of a touch-sensitive display to contain input devices that enable a game interface.

With an exemplary embodiment of the present invention, the laptop 100 may be used sideways or in the horizontal position, as illustrated by FIG. 2. The two displays 110 and 120 of the laptop 100 being open in a relatively flat position is suitable for giving a presentation to a small group of people. For example, two slides may be shown simultaneously, one on each display, or one slide may be shown using both displays with text on one display and graphics or pictures on the other display. A small area (not shown) may be provided at a corner of one display to provide the few input devices for slide navigation, such as paging up, paging down, going to a specific page, and the like.

The laptop 100 shown in FIG. 4 may also be used in the same manner as an open paper book. The two displays 410 and 420 may display two consecutive pages of an electronic book 430, similar to the way a paper book shows two pages at one time. A small area (not shown) at the corner of one display may be reserved for a few control buttons for navigation through the book (such as paging up, paging down, or going to a specific page). This enhances the usability of a laptop computer as a medium for book reading and increases the commercial viability of electronic books.

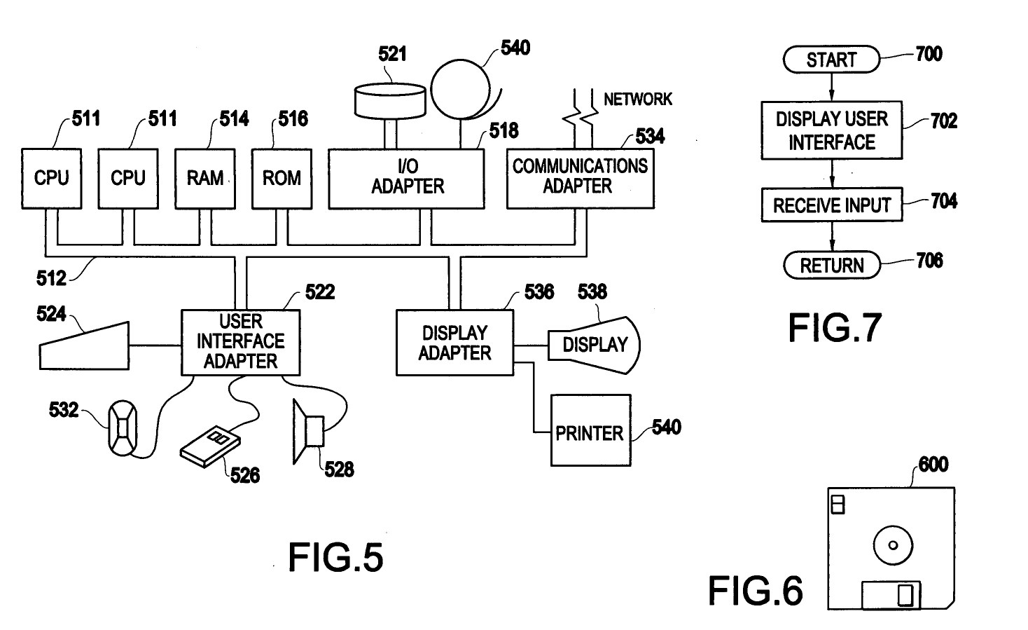

FIG. 5 illustrates an exemplary hardware configuration of an information handling/computer system for use with the invention and which preferably has at least one processor or central processing unit (CPU) 511.

The CPUs 511 are interconnected via a system bus 512 to a random access memory (RAM) 514, read-only memory (ROM) 516, input/output (I/O) adapter 518 (for connecting peripheral devices such as disk units 521 and tape drives 540 to the bus 512). The system bus 512 may also communicate with a user interface adapter 522 (for connecting additional accessories such as, for example, a keyboard 524, mouse 526, speaker 528, microphone 532, and/or other user interface device to the bus 512 of the laptop computer). The system bus 512 also communicates with a communication adapter 534 for connecting an information handling system to a data processing network, the Internet, an Intranet, a personal area network (PAN), etc., and a display adapter 536 for connecting the bus 512 to the displays 538 and a printer 540.

In addition to the hardware/software environment described above, a different aspect of the invention includes a computer-implemented method for performing the above method. As an example, this method may be implemented in the particular environment discussed above.

Such a method may be implemented, for example, by operating a laptop computer, as embodied by a digital data processing apparatus, to execute a sequence of machine-readable instructions. These instructions may reside in various types of signal-bearing media.

This signal-bearing media may include, for example, a RAM contained within the CPU 511, as represented by the fast-access storage for example. Alternatively, the instructions may be contained in another signal-bearing media, such as a magnetic data storage diskette 600 (FIG. 6), directly or indirectly accessible by the CPU 511.

Whether contained in the diskette 600, the laptop computer/CPU 511, or elsewhere, the instructions maybe stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media, such as digital and analog and communication links and wireless links. In an illustrative embodiment of the invention, the machine-readable instructions may comprise software object code, compiled from a language such as “C”, etc.

FIG. 7 illustrates an exemplary control routine that incorporates the features of one method of the present invention. In this exemplary method, the control routine may be executed when an application that is currently running on the laptop computer invokes the routine of FIG. 7 in order to obtain a user input. The control routine starts at step 700 and continues to step 702 where the control routine displays a user-interface on the touch-screen display 110. The control routine then continues to step 704 where the control routine receives an input from the user using the user-interface on the touch-screen display 110. As explained above, the user-interface may be any one or more of several forms, such as a keyboard, or the like.

In this manner, the present invention allows an application that is running on a laptop computer that has two displays, one of which is a touch-screen display, to receive input from a user at appropriate times during execution of the application.

When the control routine receives the input from the user in step 704, the control routine returns control to the application and/or process that invoked the control routine of FIG. 7. The application may then continue operating to, for example, continue to request input and re-invoke the control routine of FIG. 7, or may display something else on the touch-screen display.

While the invention has been described in terms of several exemplary embodiments, those skilled in the art will recognize that the invention can be practiced with modification.

Further, it is noted that, Applicant's intent is to encompass equivalents of all claim elements, even if amended later during prosecution.

1. A laptop computer comprising:
a first display; and
a second display attachable to the first display, wherein the second display comprises a touch-sensitive display.

2. The computer of claim 1, wherein the second display is rotatably attachable to the first display.

3. The computer of claim 1, wherein the second display displays a user-interface.

4. The computer of claim 3, wherein the user-interface comprises a keyboard.

5. The computer of claim 3, wherein the user-interface comprises a pointing device.

6. The computer of claim 3, wherein the user-interface is reconfigurable in accordance with instruction from a software application being executed on the laptop computer.

7. The computer of claim 1, wherein the first display comprises a touch-sensitive display.

8. A method of driving a laptop computer having a first display attachable to a second display that is touch-sensitive, the method comprising:
displaying a user-interface on the second display; and
receiving an input from the user-interface.

9. The method of claim 8, wherein the first display is rotatably attachable to the second display.

10. The method of claim 8, wherein the user-interface comprises a keyboard.

11. The method of claim 10, further comprising reconfiguring the user-interface.

12. The method of claim 11, wherein reconfiguring the user-interface comprises reconfiguring the user-interface in response to an application state.

13. The method of claim 11, wherein reconfiguring the user-interface comprises reconfiguring the user-interface in response to a user preference.

14. The method of claim 11, wherein reconfiguring the user-interface comprises reconfiguring the user-interface in response to a user instruction.

15. The method of claim 11, wherein reconfiguring the user-interface comprises one of changing the size of the user-interface, changing the location of the user-interface, moving a key within the user-interface, removing a key from the user-interface, changing a label on a key on the user-interface, and changing a color of a key on the user-interface.

16. The method of claim 8, further comprising displaying a hot key that triggers the execution of a plurality of instructions in accordance with a state of the laptop computer.

17. The method of claim 8, further comprising displaying an application result.

18. The method of claim 17, wherein displaying an application result comprises displaying a first page of an electronic book on one of the first display and the second display.

19. The method of claim 18, wherein the displaying of the application result further comprises displaying a second page of an electronic book on the other one of the first display and the second display.

20. The method of claim 8, further comprising displaying a drop-down menu on the second display.

21. The method of claim 8, wherein displaying the keyboard comprises displaying a color-coded keyboard.

22. A signal-bearing medium tangibly embodying a program of machine-readable instructions executable by a digital processor for driving a laptop computer having a first display attachable to a second display that is touch-sensitive apparatus, the program comprising:
instructions for displaying a user-interface on the second display; and
instructions for receiving an input from the user-interface.

23. A laptop computer comprising:
a first display;
a second display that is touch sensitive and attached to the first display;
means for displaying a user-interface on the second display, and
means for receiving an input from the user-interface

24. A method of providing a display for a laptop computer, the method comprising:
providing a first display; and
providing a second display attachable to the first display, wherein the second display comprises a touch-sensitive display.

25. A laptop computer comprising:
a first display; and
a second display attachable to the first display, wherein the second display comprises a customizable user-interface.
